(19) United States
(12) Patent Application Publication
(10) Pub. No.: US 2009/0073276 A1
(43) Pub. Date: Mar. 19, 2009

(54) IMAGE PROCESSING SYSTEM, METHOD THEREOF AND IMAGE CAPTURING DEVICE WITH IMAGE PROCESSING SYSTEM

(75) Inventor: Chang-Chiang Lin, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/138,427

(22) Filed: Jun. 13, 2008

(30) Foreign Application Priority Data
Sep. 18, 2007 (CN) 200710201747.3

(51) Int. Cl. H04N 5/228

(52) U.S. Cl. 348/222.1; 348/E05.031

(57) ABSTRACT

An image capturing device includes an image capturing unit, and an image processing system. The image capturing unit is configured for capturing images, including a first image of an object plus a background and a second image of the background only. The image processing system includes a color value measuring module, and a foreground image generating module. The color value measuring module is configured for measuring color value of each pixel of the second image and obtaining pixels of the first image corresponding to the object. The foreground image generating module is configured for extracting a foreground image consisting of the pixels of the first image corresponding to the object.

### TECHNICAL FIELD

The present invention relates to image capturing devices and, particularly, to an image capturing device with an image processing system and method which can generate a foreground image for a composite image.

### DESCRIPTION OF THE RELATED ART

Conventional methods and systems of generating composite images allow a user to extract people or objects from a scene to form a foreground image, and composite them in front of a different, “fun” background, such as a Las Vegas skyline or an image of the moon. In the past, a method has been used to accomplish this result: the people/objects of interest may be captured in front of any type of background, and then “cut” out of the background electronically using software tools available software packages such as Adobe Photoshop™ version 6.0, for example. Nonetheless, use of such software tools to do photo editing is a time-consuming and difficult process.

What is needed, therefore, is an image processing system and method which can generate a foreground image for a composite image.

### SUMMARY

In accordance with one present embodiment, an image capturing device includes an image capturing unit, and an image processing system. The image capturing unit is configured for capturing images, including a first image of a object plus a background and a second image of the background only. The image processing system includes a color value measuring module, and a foreground image generating module. The color value measuring module is configured for measuring color value of each pixel of the second image and obtaining a red value range, a green value range, and a blue value range of all pixels of the second image. The color value measuring module is further configured for dividing the pixels of the first image into a first group of pixels whose color values are in the formed color value ranges, and a second group of pixels, each of which has at least one of the color values exceeding the corresponding color value range. The foreground image generating module is configured for extracting a foreground image consisting of the second group of pixels from the first image.

### BRIEF DESCRIPTION OF THE DRAWING

Many aspects of the present image processing system, method, and image capturing device can be better understood with reference to the accompanying drawings. The components in the drawing are not necessarily drawn to scale, the emphasis instead being placed upon clearly illustrating the principles of the present image processing system and method, and image capturing device. Moreover, in the drawings, like reference numerals designate corresponding parts throughout the several views.

FIG. 1 is a functional block diagram of an image capturing device including an image processing unit according to an embodiment.

FIG. 2 is a functional block diagram of the image processing unit of FIG. 1.

FIG. 3 is a flowchart of an image processing method according to an embodiment.

FIG. 4 is an image of a background.

FIG. 5 is an image of the background of FIG.4 plus an object of interest in the foreground of the image.

FIG. 6 is an image of just the foreground of FIG. 5 generated using the images of FIGS. 4 and 5.

FIGS. 7 and 8 are two different background images.

FIG. 9 is a composite image using the foreground image of FIG. 6 and the background image of FIG. 7.

FIG. 10 is a composite image using the foreground image of FIG. 6 and the background image of FIG. 8.

### DETAILED DESCRIPTION OF THE EMBODIMENTS

Embodiments will now be described in detail below, with reference to the drawings.

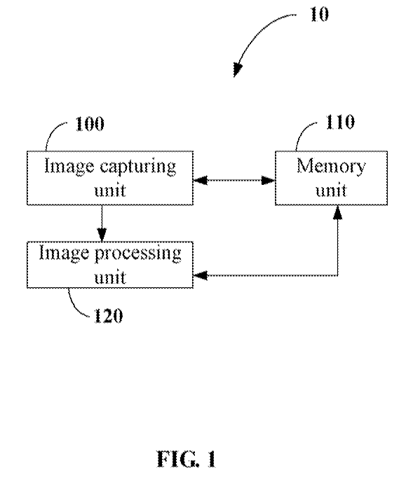

Referring to FIG. 1, an image capturing device 10 according to an embodiment includes an image capturing unit 100, a memory unit 110, and an image processing system 120, all electrically connected together. The image capturing device 10 is configured for working in a normal mode and a background replacing mode. In the normal mode, the image capturing device 10 can capture an image the same way as an ordinary image capturing device. In the background replacing mode, the image capturing device 10 can store or output an image with a replaced background.

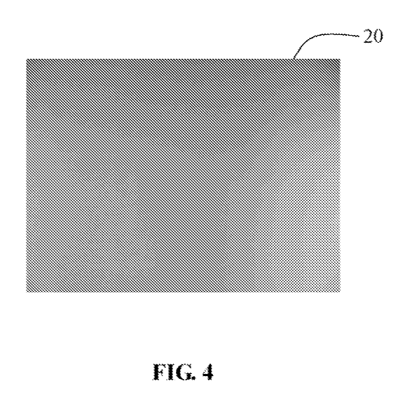

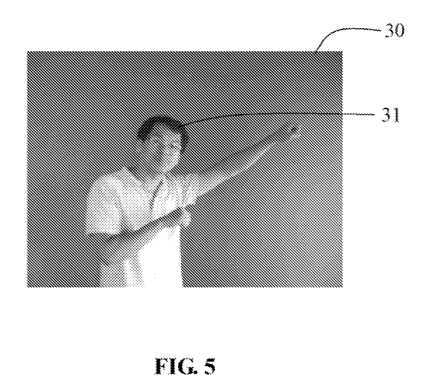

The image capturing unit 100 is configured for capturing images. In the background replacing mode, the images captured by the image capturing unit 100 include a first image 30 of an object of interest plus a background (see FIG. 5), and a second image 20 of the background only, (see FIG. 4). In the present embodiment, the background has a substantial similar color to that of the object of interest. In particular, the color of the background is greatly different from that of the object of interest. Concretely, the background can be a grey wall which can be easily found.

The memory unit 110 is configured for storing images captured by the image capturing unit 100 and images processed by the image processing system 1 20. The memory unit 110 can also be used for storing images input from peripheral equipments, such as computers and so on.

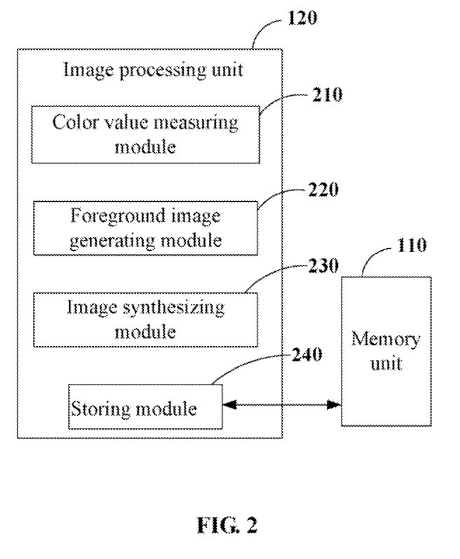

Referring to FIG. 2, the image processing system 120 includes a color value measuring module 210, a foreground image generating module 220, an image synthesizing module 230, and a storing module 240.

The color value measuring module 210 is configured for measuring color values of each pixel of the second image 20, such as a red color value, a green value range, and a blue value range of all pixels of the second image 20. In the present embodiment, on a scale of 0-255, it is assumed that the red value range is from 130 to 140, the green value range is from 130 to 140, and the blue value range is from 120 to 130. Furthermore, the color value measuring module 210 can also be used for measuring color value of each pixel of the first image 30. The pixels of the first image 30 include a first group of pixels and a second group of pixels corresponding to the background and the object of interest respectively. The color values of each pixel in the first group pixels are in the formed color value ranges respectively. Each of the pixels in the second group pixels has at least one of the color values exceeding the corresponding color value range.

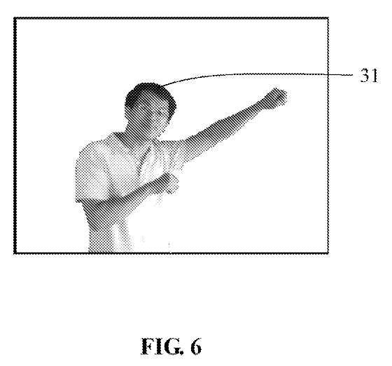

Referring to FIG. 6, the foreground image generating module 220 is configured for extracting a foreground image 31 consisting of the second group of pixels from the first image 30.

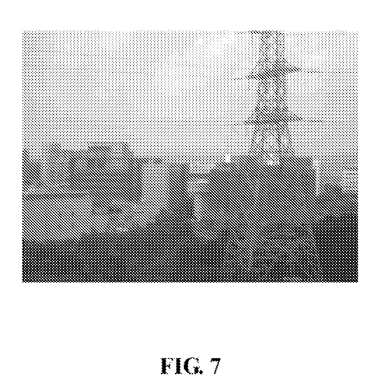

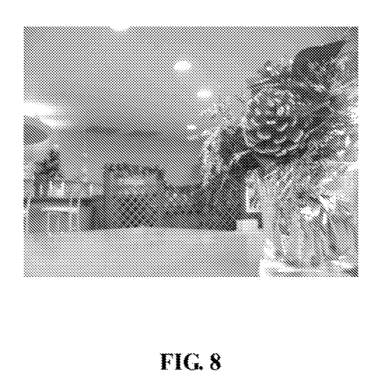

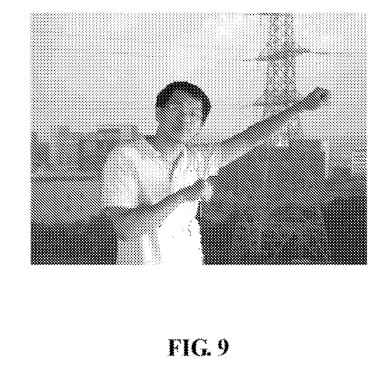

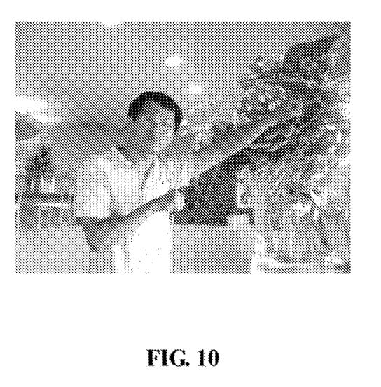

The image synthesizing module 230 is configured for combining the extracted foreground image 31 with a given background image to provide a composite image. In the present embodiment, FIG. 7 and FIG. 8 are two given background images and FIG. 9 and FIG. 10 are two composite images corresponding to the two given background images. The given background images can be stored in the memory unit 110.

The storing module 240 is configured for storing the composite images or the foreground image 31 in the memory unit 110.

The image capturing device 10 can generate a foreground image for a composite image, and thereby produce a composite image from a first image 30 of an object plus a background and a second image 20 of the background only, automatically. The first image 30 and the second image 20 can be easily obtained by users, accordingly, a foreground image for a composite image and a composite image can be easily obtained.

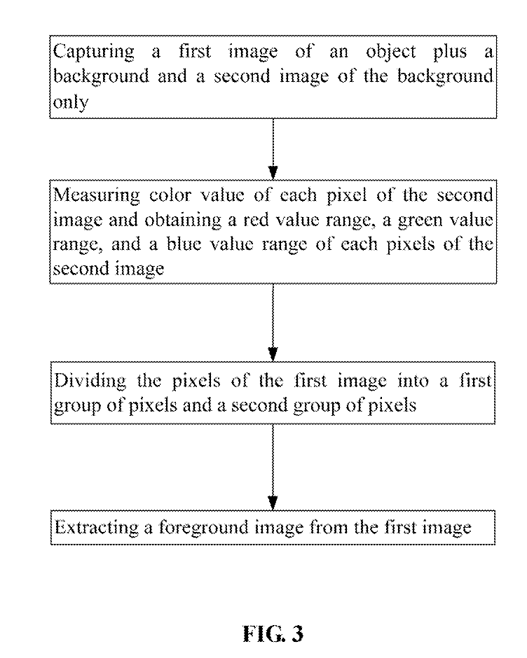

Referring to FIG. 3, an image processing method of the image capturing device 1 0 is also provided. The method, which is able to generate a foreground image for a composite image, includes the steps of: capturing a first image 30 of an object plus a background and a second image 20 of the background only; measuring color value of each pixel of the second image 20 and obtaining a red value range, a green value range, and a blue value range of each pixel of the second image 20; dividing the pixels of the first image 30 into a first group of pixels whose color values are in the formed color value ranges respectively, and a second group of pixels, each of which has at least one of the color values exceeding the corresponding color value range; and extracting a foreground image 31 consisting of the second group of pixels from the first image 30.

The foreground image 31 can be directly stored in the memory unit 110, or be used for generating a composite image by combining the extracted foreground image 31 with a given background.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An image capturing device comprising:
an image capturing unit capable of capturing a first image of an object and a background, and a second image of the background; and
an image processing system, comprising:
a color value measuring module capable of measuring a plurality of color values of each pixel of the second image to form a plurality of color value ranges, and dividing the pixels of the first image into a first group of pixels whose color values are in the formed color value ranges respectively, and a second group of pixels, each of which has at least one of the color values exceeding the corresponding color value range; and
a foreground image generating module capable of generating a foreground image consisting of the second group of pixels from the first image.

2. The device as claimed in claim 1, wherein the image processing system further comprises an image synthesizing module capable of combining the generated foreground image with a given background to provide a composite image.

3. The device as claimed in claim 1, further comprising a memory unit, the memory unit being configured for storing the generated foreground image.

4. The device as claimed in claim 1, further comprising a memory unit, the memory unit being configured for storing images for the device.

5. The device as claimed in claim 1, wherein the color of the background is different from that of the object.

6. The device as claimed in claim 1, wherein the background is a grey wall.

7. An image processing system of an image capturing device, the image capturing device comprising an image capturing unit for capturing a first image of an object plus a background, and a second image of the background, comprising:
a color value measuring module capable of measuring a plurality of color values of each pixel of the second image to form a plurality of color value ranges, and dividing the pixels of the first image into a first group of pixels whose color values are in the formed color value ranges respectively, and a second group of pixels, each of which has at least one of the color values exceeding the corresponding color value range; and
a foreground image generating module for generating a foreground image consisting of the second group of pixels from the first image.

8. The system as claimed in claim 7, wherein the image processing system further comprises an image synthesizing module for combining the generated foreground image with a given background to provide a composite image.

9. The system as claimed in claim 7, further comprising a memory unit, the memory unit being configured for storing the generated foreground image.

10. The system as claimed in claim 7, further comprising a memory unit, the memory unit being configured for storing images for the system.

11. The system as claimed in claim 7, wherein the color of the background is different from that of the object.

12. The system as claimed in claim 7, wherein the background is a grey wall.

13. An image processing method, comprising:
capturing a first image of an object plus a background and a second image of the background only;
measuring color value of each pixel of the second image and obtaining a red value range, a green value range, and a blue value range of each pixels of the second image;
dividing the pixels of the first image into a first group of pixels whose color values are in the formed color value ranges respectively, and a second group of pixels, each of which has at least one of the color values exceeding the corresponding color value range; and
extracting a foreground image consisting of the second group of pixels from the first image.

14. The method as claimed in claim 13, wherein the method further comprises a step of: storing the foreground image in a memory unit after extracting the foreground image.

15. The method as claimed in claim 1 3, wherein the method further comprises a step of: generating a composite image by combining the extracted foreground image with a given background.

16. The method as claimed in claim 1 5, wherein the method further comprises a step of: storing the composite image after generating a composite image by combining the extracted foreground image with a given background.
